(19) United States
(12) Patent Application Publication
(10) Pub. No.: US 2018/0127895 A1
(43) Pub. Date: May 10, 2018

(54) PROCESS FOR THE PREPARATION OF CARBON FELT ELECTRODES FOR REDOX FLOW BATTERIES AND PROCESS FOR PRODUCING REDOX FLOW BATTERIES

(71) Applicant: SGL CARBON SE, WIESBADEN (DE)

(72) Inventors: RUEDIGER-BERND SCHWEISS, MEITINGEN (DE); CHRISTIAN MEISER, MEITINGEN (DE)

(21) Appl. No.: 15/860,080

(22) Filed: Jan. 2, 2018

Related U.S. Application Data
(63) Continuation of application No. PCT/EP2016/064468, filed on Jun. 22, 2016.

(30) Foreign Application Priority Data
Jun. 30, 2015 (DE) 10 2015 212 234.4

(51) Int. Cl. D01F 1/10; H01M 8/18; H01M 4/66; D01F 9/22; H01M 8/0202; D06M 11/83; D06M 13/503

(52) U.S. Cl. CPC D01F 1/10; H01M 8/188; H01M 4/663; D01F 9/225; H01M 2004/021; H01M 8/0202; D06M 11/83; D06M 13/503; H01M 4/667

(57) ABSTRACT

A process prepares metal-doped felt fabric made from carbon fibers. A textile structure of pre-oxidized polyacrylonitrile fibers is carbonized at temperatures of up to 1500° C. and wherein polyacrylonitrile and/or oxidized polyacrylonitrile as precursor fibers are functionalized with a metal precursor.

### CROSS-REFERENCE TO RELATED APPLICATION

This application is a continuation, under 35 U.S.C. § 120, of copending international application No. PCT/EP2016/064468, filed Jun. 22, 2016, which designated the United States; this application also claims the priority, under 35 U.S.C. § 119, of German patent application No. 10 2015 212 234.4, filed Jun. 30, 2015; the prior applications are herewith incorporated by reference in their entirety.

### BACKGROUND OF THE INVENTION

### Field of the Invention

The subject of the invention is a method for producing felt from metal-doped carbon fibers, and the use thereof in a redox flow battery.

Secondary batteries are referred to as redox flow batteries, which secondary batteries use active masses in the form of aqueous solutions of metal salts or halides. Under operational conditions, redox flow batteries are pumped out of external tanks into an electrochemical reactor, where they are electrochemically converted during the charging and/or discharging process.

The reactor is configured as a cell stack having bipolar construction. The individual cells consist of two electrode chambers having porous carbon electrodes, which are separated by an ion-conducting membrane or a microporous separator. Redox flow batteries are also referred to as regenerative fuel cells on account of the many features they have in common with fuel cells (bipolar construction as a stack).

The cells themselves are delimited by graphite plates, which separate the individual cells and divert the currents along the stack. In contrast with conventional secondary batteries, power and capacitance can be configured independently of one another, since the capacitance is determined by the tank volumes and/or the concentration of the redox-active species in the electrolyte, while the power depends on the size, number of cells and efficiency of the cell stack.

The modular design and the decoupling of power and energy make it possible to produce flexible storage facilities which are desirable above all for electrochemical storage of energy from regenerative sources (wind and solar power).

Redox flow batteries almost exclusively use carbon in the form of needle felts as flow-through electrodes, since the highly porous structure of the fiber skeleton ensures high electrical conductivity and at the same time good permeability and homogenous fluid distribution.

The three-dimensional structure contains a high specific surface area (>150 cm²/cm³ or a BET surface area of from 0.3 to 0.8 m²/g). As a result, effective current densities are reduced and kinetically inhibited redox pairs such as V²⁺/V³⁺, VO²⁺/VO₂⁺, Br₂/Br₃⁻ or Cr²⁺/Cr³⁺ generate only moderate overvoltages.

Carbon materials such as carbon fibers or graphite are stable against aggressive electrolytes, which are used in flow batteries (for example vanadium, bromine, polysulphides or acids).

Carbon felts are compression-elastic and can be easily integrated into a filter press design of a stack. Carbon felts are produced on a large scale in a roll-to-roll process.

In the case of redox flow batteries, carbon felts are produced on the basis of polyacrylonitrile (PAN) or oxidised polyacrylonitrile (PANOX).

PAN fibers are first produced by wet-spinning of the polymer in a precipitation bath and are then dried. By means of thermal oxidation of the PAN fibers, a stabilized (oxidized) PAN fiber is produced which is processed into a needle felt. Alternatively, a needle felt may be produced from PAN fibers and oxidatively stabilized.

Subsequently, multi-stage pyrolysis of the felts occurs at temperatures of over 2000° C. in the absence of air to form carbon felts having very good electrical conductivity and a high purity (ash content <0.2%).

Redox flow batteries use aqueous solutions as active masses. For this reason, the maximum achievable cell voltage is limited. The majority of redox systems require acidic conditions (up to 5 molar sulphuric acid, hydrochloric acid or hydrobromic acid). The potential window is theoretically restricted to 1.23 V. When charging, problematic side reactions occur, such as hydrogen formation at the negative electrode or corrosion of the positive electrode by oxygen formation.

Without the kinetic inhibition of hydrogen formation (overvoltage) on carbon materials, no redox pairs having a negative electrochemical standard potential as negative masses could therefore be used in the acidic environment. Graphite, for example, has a sufficiently high overvoltage (>0.5 V) with respect to hydrogen evolution and can therefore be used as the electrode material.

Carbon felts are treated at a temperature of over 2000° C. in order to obtain fibers of a high crystallinity (graphite character) (see for example German patent DE 2 027 130 B). However, this treatment merely results in low wettability with respect to the electrolyte systems.

Therefore, carbon felts must be thermally treated in an oxygen-containing atmosphere prior to use in order to functionalize the surface and make the surface wettable (see for example U.S. Pat. No. 6,509,119 B1).

Alternatively, activation by means of electron or gamma irradiation and plasma treatment (see for example European patent application EP 2 626 936 A1) may occur. As a result, a lower cell resistance of the battery is produced, because the redox reactions of the active masses are accelerated by means of catalytically active hydroxyl or carboxyl groups and the usable surface area of the electrodes is increased on account of improved wettability.

Although similar effects may also be achieved at a reduced production temperature of the carbon felts, in this case, a clear tendency towards hydrogen formation is observed (N. Hagedorn, NASA Redox Storage System Development Project, Final Report DOE/NASA/12726-24, NASA TM-83677, 1984).

Hydrogen formation is a fundamental problem for the long-term performance of redox flow batteries, since these via an imbalance of electrolytes in the half cells to loss of capacitance and additionally represent a safety risk. Furthermore, a rise in the cell resistance is linked to the loss of capacitance as a result of the electrolyte imbalance.

In the case of iron-chromium redox flow batteries, binary catalysts based on gold and thallium by electrochemical deposition on carbon electrodes have therefore been used, which catalysts reduce the hydrogen formation and increase the reactivity of the felt with respect to the redox pair Cr²⁺/Cr³⁺ (C. D. Wu et al., J. Electrochem. Soc. 1986, volume 133, pages 2109-2112). U.S. patent publication No. 2014/0186731 A describes the use of bismuth as the hydrogen inhibitor in the electrolyte.

Alternatively, a rebalance cell can be used which oxidizes the hydrogen formed into water (see published, non-prosecuted German patent DE 2 843 312 A1) and as a result maintains the charge balance of the cell.

Similar catalysts/inhibitors based on nanoparticles have been proposed for vanadium redox flow batteries (Z. Gonzalez et al., Electrochemistry Communications, volume 13, 2011, pages 379-1382). However, the catalysts/inhibitors must be introduced into the felt using costly measures, and must be produced by galvanic deposition from electrolyte solutions.

### SUMMARY OF THE INVENTION

The object of the invention is therefore to provide a carbon felt which has an intrinsically high activity such that no costly surface treatment of the felt is necessary for reducing hydrogen formation to an acceptable extent.

This object is achieved by a method for producing metal-doped felt from carbon fibers, a textile structure composed of polyacrylonitrile fibers being carbonized at temperatures of up to 1500° C. and polyacrylonitrile as precursor fibers being functionalized with a metal precursor which produces the corresponding metals in and on the fiber during carbonization.

The object is further achieved by the use of the metal-doped felt, produced by the method according to the invention, in a redox flow battery.

The present invention thus claims a method in which catalytically active species are already integrated during production of the carbon felt. Within the meaning of the invention, carbon felt is understood to mean felt, needle felt and woven and non-woven fabric based on carbon fibers. Fibers are spun from a polyacrylonitrile polymer, a PAN spinning solution typically being produced thereby. These spun fibers are the precursor fibers. The precursor fibers are then partially oxidized, as a result of which the peroxidized polyacrylonitrile fibers are obtained.

The carbon felt is thus doped with functional metals (for example tin, bismuth, manganese, indium, lead, phosphorus and/or antimony). During carbonization, the corresponding metals are released from the metal oxides on the fiber surface by means of reduction with the previously produced carbon.

The carbonization temperature must be below the evaporation temperature of the corresponding element. Preferably, particles of metals or half metals are produced which have a high overvoltage for the hydrogen formation, form no carbides and are not toxic. Preferably, within the meaning of the invention are bismuth (boiling point 1550° C.), tin (boiling point 2600° C.), indium (boiling point 2000° C.), manganese (boiling point 2100° C.) and antimony (boiling point 1635° C.). Doping with phosphorus has positive effects on the oxidation resistance of the felt.

The battery felt can be produced in a surprisingly cost-effective manner in only a single carbonization step (instead of in two steps as is conventional) on account of a reduced carbonization temperature of, particularly preferably, <1500° C.

On account of the lower treatment temperature, the carbon felt retains a higher specific surface area and a high residual content of heteroatoms (oxygen, nitrogen). The high residual content of heteroatoms produces improved charge transfer kinetics of the active species. The tendency towards hydrogen formation of partially graphitized or graphitized felts is reduced by means of the preferred provision of inhibitors (particles of metals having high hydrogen overvoltage).

The particles are deposited preferably either by doping the PAN spinning solution with metal nanoparticles, metal salts, metal oxide particles or organometallic compounds or preferably by impregnating the PAN fiber with solutions of metal salts, metal sulphides, metal oxides or metal-containing sol-gel precursors. This may take place, for example, in that the particles are sprayed onto the fibers or in that the fibers are immersed in the solutions.

The felt preferably has a thickness of from 0.5 to 10 mm, particularly preferably from 2 to 6 mm. This meets battery requirements.

The weight per unit area is preferably from 100 to 1000 g/m², particularly preferably from 200 to 600 g/m². Thickness and weight per unit area correlate.

The BET surface area of the felt is preferably from 0.4 to 10 m²/g, particularly preferably from 0.4 to 1.5 m²/g.

The felt has a specific electrical resistance perpendicular to the felt direction of preferably from 0.5 to 10 ohm mm, particularly preferably from 1 to 4 ohm mm.

Preferably, the felt has a carbon content of from 90 to 99%, particularly preferably from 92 to 98%. As described in detail in the embodiment, the residual content (so as to come to 100%) is made up of nitrogen, oxygen and a marginal content of hydrogen.

It is preferable for the proportion of nitrogen to be from 0.2 to 5%. The nitrogen is catalytically active, as a result of which the battery is more efficient, since there are lower overvoltages from electrode reactions (e.g. vanadyl). As described in detail in the embodiment, the residual content is made up of carbon, oxygen and a marginal content of hydrogen, not taking into account ash and sulphur.

The felt has an interplanar spacing preferably of from 3.40 to 3.50 angstrom, particularly preferably from 3.45 to 3.52 angstrom.

The proportions of tin, bismuth, manganese, indium, phosphorus and/or antimony in the metal-doped felt according to the invention are in each case particularly preferably from 200 to 10000 ppm. This reduces the hydrogen overvoltage (tin, bismuth, manganese, indium and/or antimony), as a result of which the loss of capacitance during a charging operation of a battery is reduced. Phosphorus is used as a corrosion inhibitor.

The metal-doped felt is preferably inserted in a redox flow battery.

Other features which are considered as characteristic for the invention are set forth in the appended claims.

Although the invention is illustrated and described herein as embodied in a process for the preparation of carbon felt electrodes for redox flow batteries, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a graph showing voltage efficiency (in %) of an individual vanadium redox flow battery cell as a function of a current density (in mA/cm²) using two electrodes; and

FIG. 2 is a graph showing a charging efficiency (in %) of the individual vanadium redox flow battery cell as a function of the current density (in mA/cm²) using two electrodes.

### DETAILED DESCRIPTION OF THE INVENTION

### Embodiment 1

Dispersion 1A:

A solution, or dispersion, is produced from 1 wt. % bismuth(III) isopropoxide in water/isopropanol (9:1)

Dispersion 1B:

A solution, or dispersion, is produced from 0.5 wt. % bismuth(III) isopropoxide, 0.5 wt. % bismuth hexanoate and 0.4 wt. % tin isopropylate in water/isopropanol (9:1)

Dispersion 1C:

A solution, or dispersion, is produced from 1 wt. % bismuth hexanoate, 0.5 wt. % indium(III) isopropylate and 0.3 wt. % antimony(III) isopropylate in water/isopropanol (9:1).

Carbon precursor fibers made of polyacrylonitrile (1.7 dtex or 2.2 dtex) are in each case impregnated with the described dispersions (1A, 1B, 1C), dried and stabilized by means of thermal oxidation under normal atmospheric conditions at 240-280° C. The fibers thus obtained are processed into curled staple fibers (62 mm fiber length). After combing/carding, the fibers are laid to form a single-layer or multi-layer web and processed into a felt (mass per unit area of from 200 to 800 g/m²) by needle punching on one or both sides. Subsequently, carbonization takes place in an inert atmosphere in a continuous furnace at a temperature of 1480° C.

A reference sample without the addition of metal compounds was carbonized in the same manner (control sample 2). A commercial, graphitized carbon fiber Sigracell® GFD 4.6 (SGL Carbon GmbH, Meitingen) was used as another reference material (control sample 1).

### Embodiment 2

Bismuth(III) oxide (nanoscale 80-200 nm), in an amount of 3 wt. %, and indium isopropoxide, in an amount of 1 wt. %, are added to a spinning solution of polyacrylonitrile and solvent (DMF) and from this polymer fibers are produced by means of wet-spinning. After thermal oxidation of the fibers under normal atmospheric conditions at 280° C., the fibers are processed into curled staple fibers (62 mm fiber length). After combing/carding, the fibers are laid to form a single-layer or multi-layer web and processed into a felt (mass per unit area of from 400 to 700 g/m²) by means of needle punching on one or both sides. Subsequently, carbonization takes place in an inert atmosphere in a continuous furnace at a temperature of 1480° C.

Material Analyses

The specific surface area (BET) was determined by means of krypton sorption (DIN-ISO 9277). The interplanar spacing (d₀₀₂) and the crystallite height (Lₐ) were determined by X-ray diffraction from the (002) diffraction maximum (DIN EN 13925). The specific electrical resistance perpendicular to the felt plane (z) was determined by means of two-point measurement using gold contacts during compression of the felt of 80% of the initial thickness. Parameters were obtained for the materials:

| | d₀₀₂ | L_{c} | BET | Electrical |
|---|---|---|---|---|
| | (nm) | (nm) | (m²/g) | resistance (z) |
| Control sample 1 | 0.3466 | 4.7 | 0.41 | 2.4 |
| Control sample 2 | 0.3517 | 2.4 | 0.58 | 2.9 |
| Embodiment 1 | 0.3512 | 2.5 | 0.55 | 2.7 |
| Embodiment 2 | 0.3501 | 2.4 | 0.54 | 2.8 |

Electrochemical Testing

In order to determine the electrode properties, the felts and the reference material in an individual vanadium redox flow battery cell having an electrode surface area of 20 cm² were analyzed. The materials, compressed to 75% of their initial thickness, were applied to the anode and cathode, respectively. A partially fluorinated anion exchange membrane (Fumasep FAP 450, Fumatech GmbH, Bietigheim-Bissingen) was used as the separator and graphite compound plates were used as the current collector. All cell tests were carried out using 0.8 M vanadium/4M sulphate and electrolyte flow rates of 80 mL/min.

For each test, the cells were conditioned by full charging of the electrolyte. In order to determine the electrochemical characteristics of the felts, three successive charging/discharging cycles (end-of-charging voltage 1.65 V, end-of-discharging voltage 0.9 V) were carried out in each case at current densities of from 20 to 60 mA/cm².

The following were determined in each case as characteristic variables for the cell tests:

$$Voltage efficiency {η}_{v} ( \% ) = \frac{average discharge voltage ( V )}{average charging voltage ( V )} \cdot 100$$

$$Charging efficiency {η}_{L} ( \% ) = \frac{discharge capacitance ( Ah )}{charging capacitance ( Ah )} \cdot 100$$

$$Cycle resistance {R}_{Z} ( Ω \cdot {cm}^{2} ) = \frac{1.38 V}{current density ( A \text{/} {cm}^{2} )} \cdot ( \frac{100 - {η}_{v}}{100 + {η}_{v}} )$$

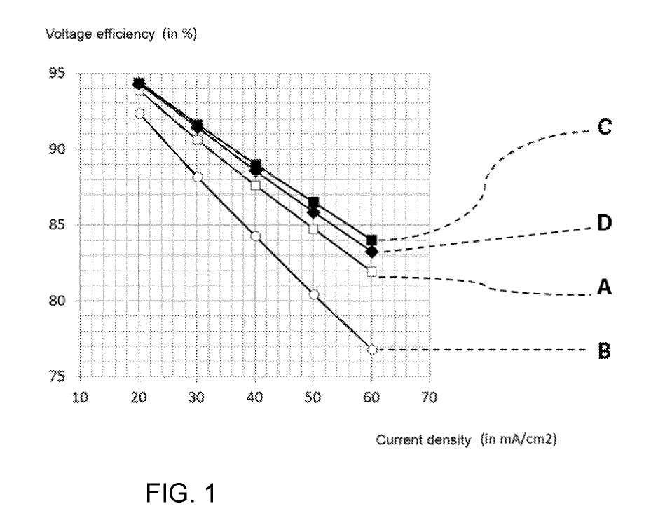

The embodiments show a clearly higher voltage efficiency (FIG. 1) and a lower cell resistance (discernible from the lower decrease in voltage efficiency with rising current density).

The cycle resistances were determined as 2.9 ohm×cm² (control sample 1), 2.3 ohm×cm² (control sample 2), 2.0 ohm×cm² (embodiment 1, dispersion 1A) and 2.1 ohm×cm² (embodiment 2).

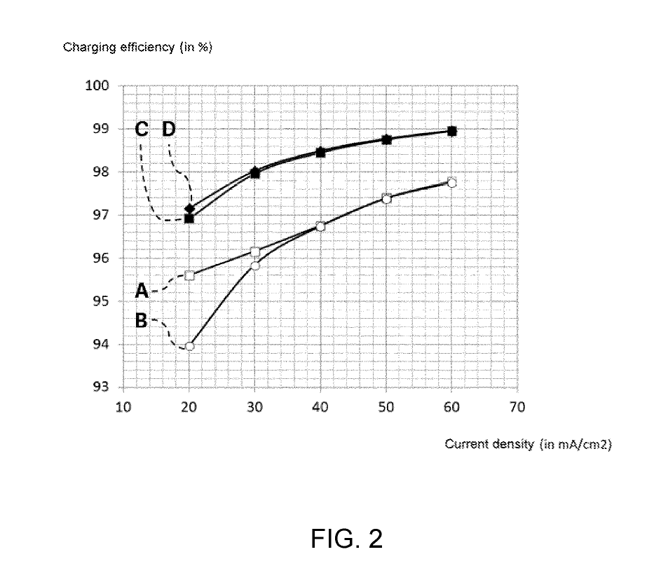

Moreover, the charging efficiency (FIG. 2) is higher than in the control samples above all at low current density, at which a high charge state (>99%) is achieved as a result of the end-of-charging voltage of 1.65 V. This indicates lower parasitic hydrogen evolution during use of the felts according to the invention.

### LEGEND FOR THE FIGURES

FIG. 1

(A): Voltage efficiency (in %) of an individual vanadium redox flow battery cell as a function of the current density (in mA/cm²) using two electrodes of the type from control sample 1

(B): Control sample 2

(C): Embodiment 1, dispersion 1A

(D): Embodiment 2

FIG. 2

(A): Charging efficiency (in %) of an individual vanadium redox flow battery cell as a function of the current density (in mA/cm²) using two electrodes of the type from control sample 1

(B): Control sample 2

(C): Embodiment 1, dispersion 1A

(D): Embodiment 2

1. A method for producing metal-doped felt from carbon fibers, which comprises:
carbonizing a textile structure composed of peroxidized polyacrylonitrile fibers at temperatures of up to 1500° C. and polyacrylonitrile as precursor fibers being functionalized with a metal precursor.

2. The method according to claim 1, which further comprises forming the metal-doped felt to have a thickness of from 0.5 to 10 mm.

3. The method according to claim 1, which further comprises forming the metal-doped felt to have a weight per unit area of from 100 to 1,000 g/m².

4. The method according to claim 1, which further comprises forming the metal-doped felt to have a BET surface area of from 0.4 to 10 m²/g.

5. The method according to claim 1, which further comprises forming the metal-doped felt to have a specific electrical resistance perpendicular to a felt direction of from 0.5 to 5 ohm mm.

6. The method according to claim 1, which further comprises forming the metal-doped felt to have a carbon content of from 90 to 99%.

7. The method according to claim 1, which further comprises forming the metal-doped felt to have a proportion of nitrogen of from 0.2 to 5%.

8. The method according to claim 1, which further comprises forming the metal-doped felt to have an interplanar spacing of from 3.40 to 3.55 angstrom.

9. The method according to claim 1, which further comprises forming the metal-doped felt with proportions of tin, bismuth, manganese, indium, phosphorus and/or antimony in each case from 200 to 5000 ppm.

10. A method of producing a battery, which comprises the steps of:
producing a metal-doped felt from carbon fibers by carbonizing a textile structure composed of peroxidized polyacrylonitrile fibers at temperatures of up to 1500° C. and polyacrylonitrile as precursor fibers being functionalized with a metal precursor; and
using the metal doped felt in a redox flow battery.
